(19) United States
(12) Patent Application Publication
(10) Pub. No.: US 2026/0274695 A1
(43) Pub. Date: Sep. 17, 2026

(54) AMMONIA SYNTHESIS SYSTEM WITH A SOLID OXIDE FUEL CELL SYSTEM

(71) Applicant: FuelCell Energy, Inc., Danbury, CT (US)

(72) Inventor: Jonathan MALWITZ, Bethel, CT (US)

(21) Appl. No.: 19/560,728

(22) Filed: Mar. 9, 2026

Related U.S. Application Data
(60) Provisional application No. 63/772,931, filed on Mar. 17, 2025.

(51) Int. Cl. C01C 1/04; H01M 8/1246

(52) U.S. Cl. CPC C01C 1/0488; H01M 8/1246

(57) ABSTRACT

An ammonia synthesis system includes an ammonia reactor configured to convert nitrogen and hydrogen in a first gas stream to ammonia and to output an ammonia reactor output stream and a solid oxide fuel cell system comprising an anode portion configured to receive a residual gas stream separated from ammonia in the ammonia reactor output stream.

### CROSS REFERENCE TO RELATED APPLICATIONS

This application claims the benefit of and priority to U.S. Provisional Patent Application No. 63/772,931, filed March 17, 2025, which is incorporated by reference herein in its entirety.

### BACKGROUND

The present disclosure relates generally to the field of ammonia production. In particular, the present disclosure relates to improving the energy efficiency of an ammonia production system using solid oxide fuel cells.

The production of ammonia from natural gas includes several operations used to produce a mixture of nitrogen gas and hydrogen gas that are then reacted to form ammonia (NH₃). First, natural gas undergoes steam reforming to convert the natural gas and steam to carbon monoxide, carbon dioxide, and hydrogen. Air is also added to provide nitrogen to the gas mixture. The gas mixture then undergoes water gas shift reactions to convert the carbon monoxide and additional steam to carbon dioxide and additional hydrogen. Carbon dioxide is removed from the mixture, leaving primarily hydrogen gas and nitrogen gas, along with trace amounts of carbon monoxide and carbon dioxide. All or nearly all of the remaining carbon monoxide and carbon dioxide may be removed and converted to methane in a methanation process. Finally, the mixture of primarily hydrogen, nitrogen, and methane may be provided to an ammonia reactor, in which the nitrogen and hydrogen react to form ammonia.

The output from the ammonia reactor is cooled to condense most of the ammonia, which can be separated from the remaining uncondensed gas mixture, including methane, argon, unreacted hydrogen and nitrogen, and uncondensed ammonia. This gas mixture may be supplied to a hydrogen recovery unit, which separates hydrogen from the mixture and recycles it back to the ammonia reactor, and the remaining gases are purged from the system in a purge gas or burned to heat the reformers. It may be desirable to use the uncondensed gas mixture or the purge gas stream for other, more energy-efficient purposes.

### SUMMARY

One aspect of the present disclosure relates to an ammonia synthesis system including: an ammonia reactor configured to convert nitrogen and hydrogen in a first gas stream to ammonia and to output an ammonia reactor output stream; a hydrogen recovery unit configured to receive a residual gas stream separated from ammonia in the ammonia reactor output stream and to output a hydrogen stream including purified hydrogen and a purge gas stream including nitrogen and residual hydrogen separated from the hydrogen stream; and a solid oxide fuel cell system including an anode portion configured to receive an anode input stream including the purge gas stream.

Another aspect of the present disclosure relates to a method of generating ammonia, the method including: converting nitrogen and hydrogen in a first gas stream to ammonia in an ammonia reactor to generate an ammonia reactor output stream; separating the ammonia reactor output stream into a liquid ammonia stream and a residual gas stream; separating the residual gas stream into a hydrogen stream including purified hydrogen and a purge gas stream including hydrogen and nitrogen; and supplying the purge gas stream to an anode portion of a solid oxide fuel cell system.

Another aspect of the present disclosure relates to an ammonia synthesis system including: an ammonia reactor configured to convert nitrogen and hydrogen in a first gas stream to ammonia and to output an ammonia reactor output stream; and a solid oxide fuel cell system including an anode portion configured to receive a residual gas stream separated from ammonia in the ammonia reactor output stream.

Another aspect of the present disclosure relates to a method of generating ammonia, the method including: converting nitrogen and hydrogen in a first gas stream to ammonia in an ammonia reactor to generate an ammonia reactor output stream; separating the ammonia reactor output stream into a liquid ammonia stream and a residual gas stream; and supplying at least a portion of the residual gas stream to an anode portion of a solid oxide fuel cell system.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the devices and/or processes described herein, as defined by the claims, will become apparent in the detailed description set forth herein and taken in conjunction with the accompanying drawings.

### BRIEF DESCRIPTION OF THE DRAWINGS

FIG. 1 is a schematic diagram of a prior art ammonia synthesis system.

FIG. 2 is a schematic diagram of a solid oxide fuel cell according to an exemplary embodiment.

FIGS. 3 and 4 are schematic diagrams of ammonia synthesis systems according to exemplary embodiments.

FIGS. 5A and 5B illustrate a method of generating ammonia according to an exemplary embodiment.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As discussed above, it may be desirable to use the uncondensed gases separated from liquid ammonia or the purge gas stream from a hydrogen recovery unit in more energy-efficient ways. The systems disclosed herein integrate solid oxide fuel cell systems into the ammonia synthesis process to improve the overall efficiency of the process. For example, in some embodiments, the purge gas stream from the hydrogen recovery unit may be provided to the anode portion of a solid oxide fuel cell system to generate power. In some embodiments, the hydrogen recovery unit may not be included in the ammonia synthesis system, and the uncondensed gas mixture separated from the condensed ammonia may be directly supplied to the anode portion of a solid oxide fuel cell system. Cathode exhaust from the solid oxide fuel cell system, which may contain oxygen-depleted air, may be supplied to the ammonia synthesis process as a source of nitrogen without adding a substantial amount of oxygen to the system. Hydrogen remaining in the anode exhaust of the solid oxide fuel cell system may then be separated and recycled for use in the ammonia synthesis process.

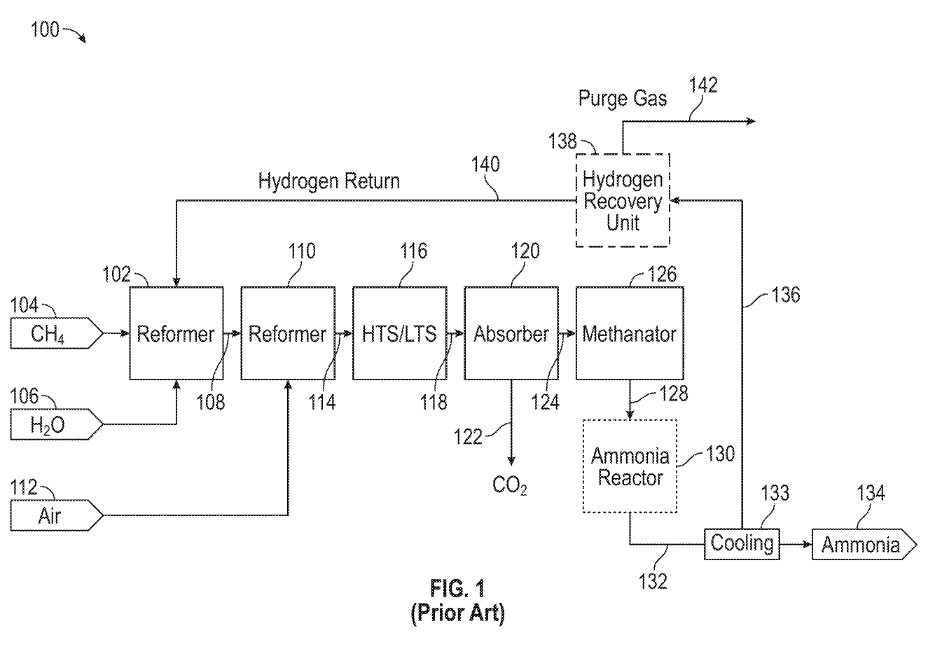

Referring now to FIG. 1, an ammonia synthesis system 100 is shown according to an exemplary embodiment. The ammonia synthesis system includes a first reformer system 102 that receives a natural gas stream 104 containing methane and a steam stream 106. In the first reformer system 102, the steam from the steam stream 106 and methane from the natural gas stream 104 react in steam reforming reactions to form a mixture of carbon monoxide, carbon dioxide, hydrogen gas, and residual unreacted methane. This mixture is output from the first reformer system 102 as a first reformer system output stream 108. The first reformer system output stream 108 is then supplied to the second reformer system 110 along with an air stream 112. The air stream 112 may be made up of atmospheric air, including about 78 percent nitrogen and 21 percent oxygen. The air stream 112 thus supplies the nitrogen for the downstream ammonia production. In the second reformer system 110, methane remaining in the first reformer system output stream 108 reacts with oxygen from the air stream 112 to form additional carbon monoxide and hydrogen in a process referred to as secondary reforming. The air stream 112 also provides nitrogen for ammonia production downstream. The second reformer system 110 outputs a second reformer system output stream 114 including nitrogen, hydrogen, carbon dioxide, carbon monoxide, and other gases in lower concentrations, such as residual steam.

The second reformer system output stream 114 is supplied to a shift system 116, in which the second reformer system output stream 114 undergoes high-temperature and low-temperature water-gas shift reactions, converting carbon monoxide and steam to carbon dioxide and hydrogen. Additional steam may be supplied to the shift system 116 if there is insufficient residual steam in the second reformer system output stream 114. The shift system 116 outputs a shift system output stream 118, which may include nitrogen, hydrogen, carbon dioxide, and relatively small amounts of carbon monoxide and other gases (argon, etc.).

The shift system output stream 118 is provided to a carbon dioxide absorber system 120. The carbon dioxide absorber system 120 may be or may include a carbon dioxide scrubber that absorbs carbon dioxide in the shift system output stream 118 and removes it via a carbon dioxide output stream 122. The remaining gases are output in the absorber output stream 124, which may include nitrogen, hydrogen, and relatively small amounts of residual carbon dioxide, carbon monoxide, and other gases.

The absorber output stream 124 is then supplied to a methanation system 126, in which residual carbon dioxide and carbon monoxide react with hydrogen to form methane and steam. Carbon dioxide and carbon monoxide may interfere with the catalyst in the downstream ammonia synthesis reaction. Therefore, the methanation of the absorber output stream 124 in the methanation system 126 may be beneficial to the production of ammonia despite the consumption of some of the hydrogen gas in the methanation reaction. The methanation system 126 outputs a methanation system output stream 128 (which may be referred to herein as a first gas stream), which may include nitrogen, hydrogen, methane, steam, very low levels of carbon monoxide and carbon dioxide, and other trace gases.

The ammonia reactor 130 is configured to cause a first gas stream (e.g., the methanation system output stream 128) containing nitrogen and hydrogen to react to form ammonia in the presence of a catalyst. The methanation system output stream 128 may be supplied to the ammonia reactor as the first gas stream. The methanation system output stream 128 may have a molar ratio of nitrogen to hydrogen of about 1:3, the same ratio as that of ammonia (NH₃), to maximize the utilization rates of the nitrogen and hydrogen in the ammonia synthesis reaction. The ammonia reactor 130 outputs an ammonia reactor output stream 132, which may include gaseous ammonia, unreacted hydrogen and nitrogen, methane, steam, and other trace gases (e.g., argon). The ammonia reactor output stream 132 is then cooled by a cooling system 133 to condense the gaseous ammonia into liquid ammonia, which can then be separated from the remaining gases. The cooling system 133 may include compressors, condensers, chillers, etc. configured to reduce the temperature of the ammonia reactor output stream 132 and condense the ammonia therein. The liquid ammonia may be removed from the system 100 (e.g., for other uses, storage, etc.) via the liquid ammonia stream 134. The remaining gases separated from the liquid ammonia form a residual gas stream 136 that is supplied to a hydrogen recovery unit 138. The residual gas stream 136 may include gaseous ammonia that did not condense into a liquid, unreacted hydrogen and nitrogen, methane, steam, and other trace gases (e.g., argon).

The hydrogen recovery unit 138 may be or may include a hydrogen-permeable membrane that allows hydrogen gas in the residual gas stream 136 to pass through while the other gases in the residual gas stream 136 do not. In other embodiments, the hydrogen recovery unit 138 may be or may include a pressure swing adsorption system that separates hydrogen gas from other gas species. The hydrogen gas is output from the hydrogen recovery unit 138 as a hydrogen recycle stream 140 and recycled to the first reformer system 102. This may improve the efficiency of the system 100 by capturing and recycling hydrogen that may otherwise be purged from the system 100 or burned to heat the reformer systems 102, 110, as less new natural gas may need to be added to produce hydrogen for the ammonia synthesis reaction. The gases separated from the hydrogen recycle stream 140 in the hydrogen recovery unit 138 (e.g., gases that do not pass through the membrane) are purged from the system 100 via the purge gas stream 142. The purge gas stream 142 may include about 60 percent hydrogen (e.g., hydrogen that passes through the hydrogen recovery unit 138 without crossing the membrane), about 20 percent nitrogen, about 10 percent methane, about 5 percent argon, and about 4 percent gaseous ammonia. In some embodiments, the purge gas stream 142 may be referred to as a portion of the residual gas stream 136 from which the hydrogen recovery unit 138 has removed hydrogen (a portion of the hydrogen in the residual gas stream 136).

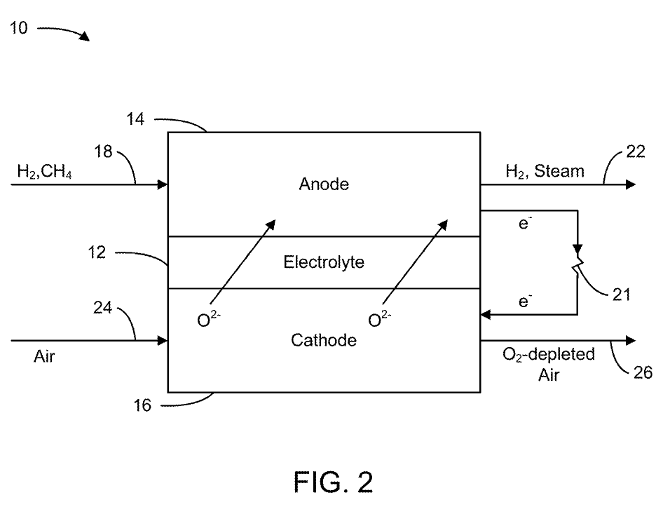

Referring now to FIG. 2, a solid oxide fuel cell (SOFC) 10 is shown according to an exemplary embodiment. The SOFC 10 includes an electrolyte 12 sandwiched between an anode 14 and a cathode 16. An anode input stream 18 including hydrogen is supplied to the anode 14. A cathode input stream 24 including oxygen (e.g., air) is supplied to the cathode 16. Oxygen in the cathode input stream 24 combines with electrons to form oxide ions that are transported over the electrolyte 12 to the anode 14. At the anode 14, the oxide ions react with the hydrogen gas to form steam (H₂O). The anode 14 outputs an anode exhaust stream 22 including the steam and unreacted hydrogen gas from the anode input stream 18. The electrons released during the reaction between the oxide ions and hydrogen travel through an external circuit back to the cathode 16, generating an electrical current that can be used to power a load 21. The cathode 16 outputs a cathode exhaust stream 26 including oxygen-depleted air. In some embodiments, the anode input stream 18 may include other fuels, such as carbon monoxide or methane. Carbon monoxide may react with oxide ions at the anode 14 to form carbon dioxide. In the presence of reforming catalyst in the SOFC 10, methane may undergo a steam methane reforming reaction in which the methane reacts with steam to form hydrogen and carbon monoxide, which react with the oxide ions as discussed above.

Multiple SOFCs may be arranged in SOFC stacks, and multiple SOFC stacks may be arranged in an SOFC module. The SOFC module may include a module housing, which may act as a pressure vessel to maintain the SOFC stacks at an elevated pressure (e.g., above atmospheric pressure). The cathodes of the SOFCs in a module and the gas flow structures that move reactants and products into and out of the cathodes may be collectively referred to as a cathode section or cathode portion. Similarly, the anodes of the SOFCs in a module and the gas flow structures that move reactants and products into and out of the anodes may be collectively referred to as an anode section or anode portion.

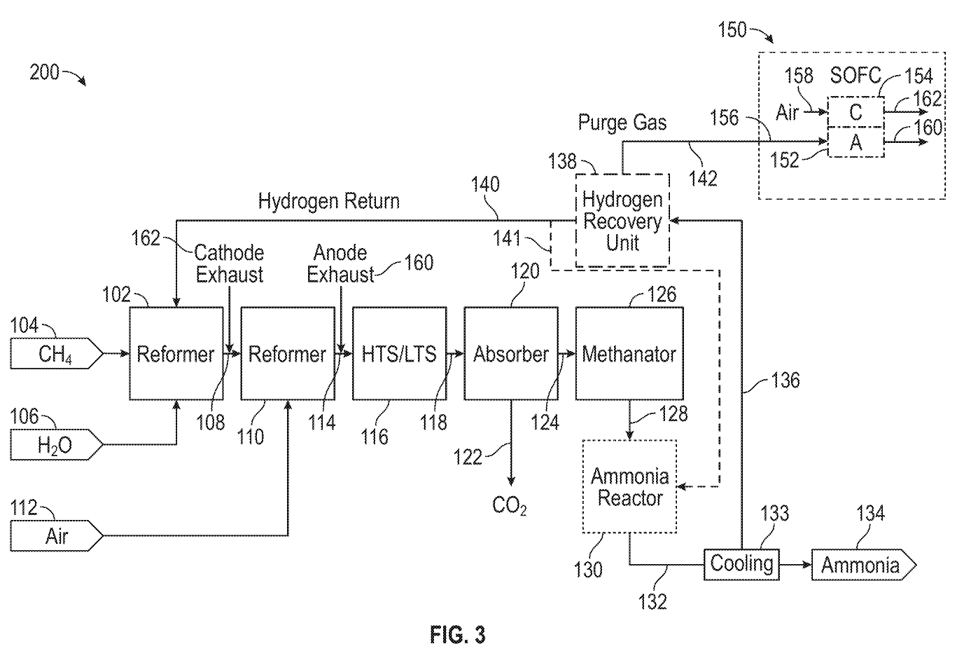

Referring now to FIG. 3, an ammonia synthesis system 200 incorporating an SOFC system 150 is shown. The ammonia synthesis system 200 may be substantially similar to the ammonia synthesis system 100 except as shown and described herein. The SOFC system 150 may be substantially similar to the SOFC 10 except that the SOFC system 150 may include multiple SOFCs 10 in a stack or a module as discussed above. The SOFC system 150 includes an anode portion 152 representing one or more anodes and a cathode portion 154 representing one or more cathodes. The anode input stream 156 is supplied to the anodes in the anode portion 152, and the cathode input stream 158 is supplied to the cathodes in the cathode portion 154. The anode portion 152 outputs the anode exhaust stream 160 including the anode exhaust from each of the fuel cells in the SOFC system 150, and the cathode portion 154 outputs the cathode exhaust stream 162 including the cathode exhaust from each of the fuel cells in the SOFC system 150.

As shown in FIG. 3, the purge gas stream 142 from the hydrogen recovery unit 138 is supplied to the anode portion 152 of the SOFC system. In some embodiments, the anode input stream 156 is entirely made up of the purge gas stream 142. In other embodiments, additional fuel may be mixed with the purge gas stream 142 to form the anode input stream 156. The cathode input stream 158 may be made up entirely or at least partially of air. The SOFC system may be configured to perform internal reforming. For example, the anode portion 152 of the SOFC system 150 may include catalyst configured to cause a steam-reforming reaction between the methane in the anode input stream 156 and the steam formed in the anodes of the SOFCs in the SOFC system 150 to form additional hydrogen (in addition to carbon dioxide and carbon monoxide). The ammonia in the anode input stream 156 may also decompose into nitrogen and hydrogen at the high temperatures in the SOFC system 150, and in some cases, in the presence of additional catalyst. At least some of the hydrogen formed from the reforming of methane and decomposition of ammonia may react with the oxide ions to form steam. In some embodiments, because the hydrogen recycle stream 140 contains nearly pure hydrogen, the hydrogen recycle stream 140 may be supplied to the shift system 116, the absorber 120, the methanator 126, or directly to the ammonia reactor 130 (e.g., via the hydrogen recovery unit 138 to reactor stream 141) and mixed with the other gas streams (e.g., streams 114, 118, 124, 128) provided thereto.

As discussed above, oxide ions from oxygen in the cathode input stream 158 are transported across the electrolytes of the fuel cells in the SOFC system 150 and react with the hydrogen (e.g., from the hydrogen in the anode input stream 156 as well as the hydrogen produced in the steam reforming and ammonia decomposition reactions in the anode portion 152) to form steam, while the SOFCs produce an electrical current. Thus, electrical power is generated from the purge gas stream 142 that would otherwise be purged from the system 200. The reactions in the SOFC system 150 are generally exothermic, so cooling of the SOFC system may be needed to maintain the proper operating temperatures. The reforming of methane and decomposition of ammonia are both endothermic processes that, by occurring in the anode portion 152, provide cooling to the SOFC system 150, improving the efficiency of the SOFC system 150 by reducing the need for external cooling systems.

The anode exhaust stream 160 may include unreacted hydrogen from the anode input stream, additional unreacted hydrogen produced in the steam reforming reaction and the ammonia decomposition, steam generated by the reaction of hydrogen with the oxide ions, carbon dioxide and carbon monoxide generated in the steam reforming of the methane, and nitrogen, argon, methane, and ammonia that pass through the anode portion 152 without reacting. To maximize the power output of the SOFC system 150, the hydrogen utilization rate may be relatively low, ensuring that there is adequate hydrogen contacting the surfaces of all of the anodes of the fuel cells. Thus, the amount of unreacted hydrogen in the anode exhaust stream 160 may be relatively high.

In some embodiments, at least a portion of the anode exhaust stream 160 may be supplied to the shift system 116 (e.g., mixed with the second reformer system output stream 114). Because the anode exhaust stream 160 contains relatively low levels of methane, the anode exhaust stream 160 can bypass the reformer systems 102, 110 and be recycled directly to the shift system 116. By recycling the anode exhaust stream 160 to this point in the system 200, the carbon monoxide generated by the steam-methane reforming in the anode portion 152 can be shifted to carbon dioxide in the shift system, and the carbon dioxide generated by the steam-methane reforming in the anode portion 152 and the shift reaction in the shift system 116 can be removed. Using the SOFC system 150, hydrogen gas in the purge gas stream 142 can be recycled. Further, hydrogen atoms in the methane and ammonia of the purge gas stream can be separated fromtheir molecules to form additional hydrogen gas. This may improve the efficiency of the system 200 by reducing the amount of natural gas required (via the natural gas stream 104). A portion of the anode exhaust stream 160 may be removed from the system to avoid a buildup of argon and other gases.

As discussed above, oxygen is removed from the cathode input stream 158 in the fuel cells, and oxide ions are transported across the electrolyte to the anode portion 152. Thus, the cathode exhaust stream 162 may contain oxygen-depleted air that is more than 78 percent nitrogen and less than 21 percent oxygen (the respective percentages of nitrogen and oxygen in atmospheric air). In some embodiments, at least a portion of the cathode exhaust stream 162 may be supplied to the inlet of the second reformer system 110 (e.g., mixed with the first reformer system output stream 108). The cathode exhaust stream 162 may replace the air stream 112 or may reduce the rate of air required to be supplied via the air stream 112. Because the cathode exhaust stream 162 has a lower concentration of oxygen than the air stream 112, less reforming is needed to be performed in the second reformer system 110 to consume the oxygen. This may allow for a smaller reformer and may require less energy than when only the air stream 112 (e.g., and not the cathode exhaust stream 162) is provided to the second reformer system 110 as a source of nitrogen. Thus, the efficiency of the system 200 may be further improved by replacing at least a portion of the air stream 112 with the relatively low-oxygen cathode exhaust stream 162.

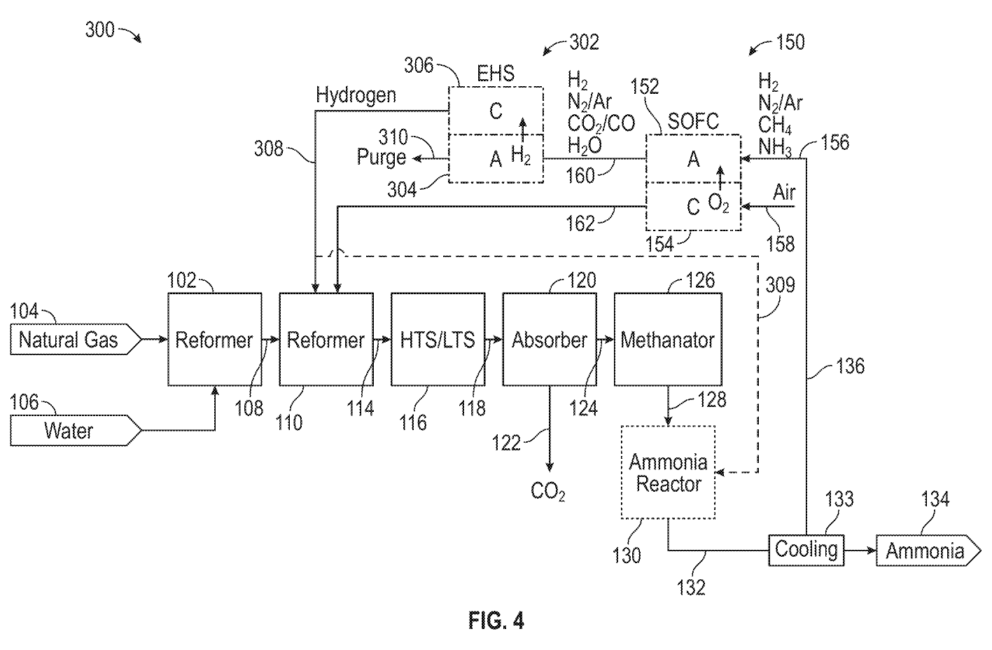

Referring now to FIG. 4, an ammonia synthesis system 300 incorporating the SOFC system 150 and an electrochemical hydrogen separator (EHS) 302 is shown. The ammonia synthesis system 300 may be substantially similar to the ammonia synthesis system 200 except as shown and described herein. The system 300 may not include a hydrogen recovery unit 138 and instead, the residual gas stream 136 separated from the liquid ammonia stream 134 by the cooling system 133 may be supplied directly to the anode portion 152 of the SOFC system 150. The anode input stream 156 may have a similar composition to that of the purge gas stream 142 but with a higher proportion of hydrogen, as no hydrogen is separated by a hydrogen recovery unit 138.

Like in the ammonia synthesis system 200, the cathode exhaust stream 162 from the SOFC system 150 may be supplied to the second reformer system 110. Rather than providing the anode exhaust stream 160 or a portion of the anode exhaust stream 160 to the shift system 116, the anode exhaust stream 160 is provided to an EHS anode 304 of the EHS 302. Hydrogen crosses over to an EHS cathode 306 of the EHS 302, while the remaining gases in the anode exhaust stream 160 do not cross over to the EHS cathode 306 and instead are purged from the EHS anode 304 and the system 300 via the EHS purge stream 310. The EHS cathode outputs an EHS hydrogen stream 308 containing nearly pure hydrogen (i.e., a purified hydrogen stream) that may be provided to the second reformer system 110. In some embodiments, because the EHS hydrogen stream 308 contains nearly pure hydrogen, the EHS hydrogen stream 308 may be supplied to the shift system 116, the absorber 120, the methanator 126, or directly to the ammonia reactor 130 (e.g., via the EHS to reactor stream 309) and mixed with the other gas streams (e.g., streams 114, 118, 124, 128) provided thereto. The EHS 302 removes carbon dioxide, carbon monoxide, and steam from the system 300 that would otherwise need to be removed via steam reforming, water-gas shift reactions, and carbon dioxide absorption before being recycled to the ammonia reactor 130. The EHS 302 also removes argon from the system 300, eliminating the need to purge a portion of the anode exhaust stream 160 to avoid a buildup of argon in the system 300.

In some embodiments, the EHS 302 may include a proton exchange membrane between the EHS anode 304 and the EHS cathode 306. Hydrogen gas may be oxidized at the EHS anode 304 to form hydrogen ions (protons), which are transported across the proton exchange membrane to the EHS cathode 306 and reduced back to hydrogen gas. The other gases in the anode exhaust stream 160 from the SOFC system 150 may not react at the EHS anode 304 or cross the proton exchange membrane. Thus, substantially pure (e.g., over 99 percent pure) hydrogen is produced in the EHS cathode 306. In some embodiments, the proton exchange membrane may be a polybenzimidazole membrane for high-temperature hydrogen separation. In some embodiments, the EHS 302 may include a phosphoric acid electrochemical cell.

It should be understood that, where a particular gas stream is described herein as being supplied to or received by a component of the ammonia synthesis system 100, 200, 300, the entire particular gas stream or only a portion of the particular gas stream may be supplied to said component. For example, another portion of the particular gas stream may be separated and supplied to other components of the system 100, 200, 300.

Using solid oxide fuel cells (i.e., the SOFC system 150) to process the purge gas stream 142 separated from the hydrogen recovery unit 138 in the system 200 or the residual gas stream 136 separated from the liquid ammonia in the system 300 may provide several advantages over other types of fuel cells, such as molten carbonate fuel cells. First, solid oxide fuel cells do not require carbon dioxide to be supplied to the cathodes to operate. In contrast, molten carbonate fuel cells cannot operate without a significant amount of carbon dioxide supplied to the cathodes. Accordingly, the systems 200, 300 do not require a carbon dioxide source or any carbon dioxide handling equipment. Instead, only air is required in the cathode input stream 158. Further, molten carbonate fuel cells transfer carbon dioxide from the cathode to the anode, over the electrolyte, while some of the carbon dioxide does not cross over. Thus, both the anode exhaust and the cathode exhaust from a molten carbonate fuel cell contain carbon dioxide. Using these molten carbonate fuel cell exhaust streams upstream in the system 200 (e.g., recycling the cathode exhaust stream 162 to the second reformer system 110 or the anode exhaust stream 160 to the shift system 116) would require expending energy to remove this carbon dioxide before recycling or would require a larger carbon dioxide absorber 120 to remove the carbon dioxide later in the process. In the ammonia synthesis system 300, the EHS 302 may remove most of the carbon dioxide from the anode exhaust stream 160 of a molten carbonate fuel cell system, but the remaining carbon dioxide in the cathode exhaust stream would still need to be removed to be used as a nitrogen source.

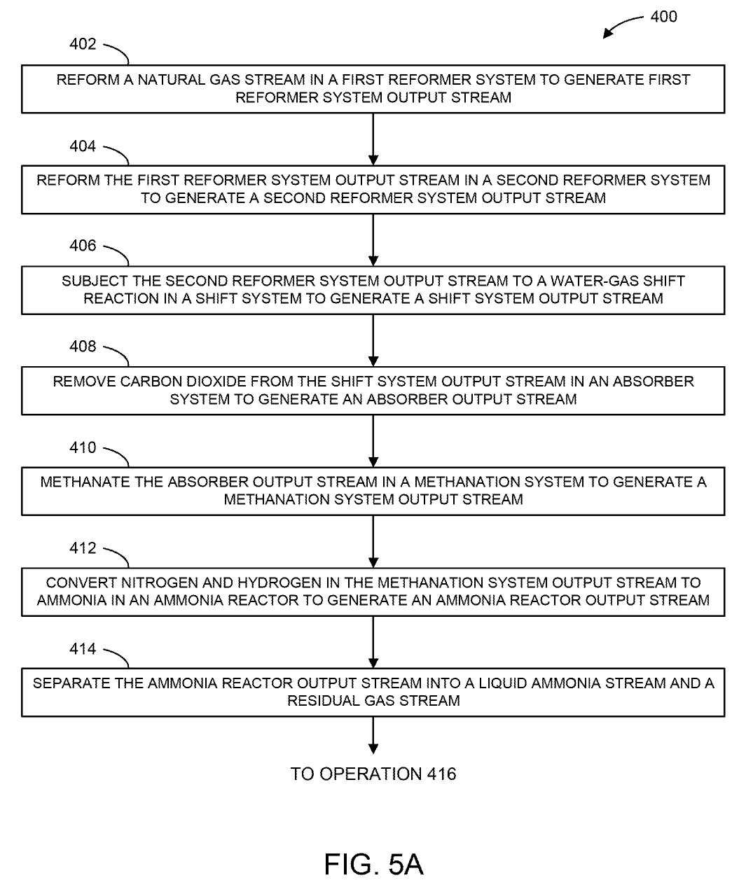

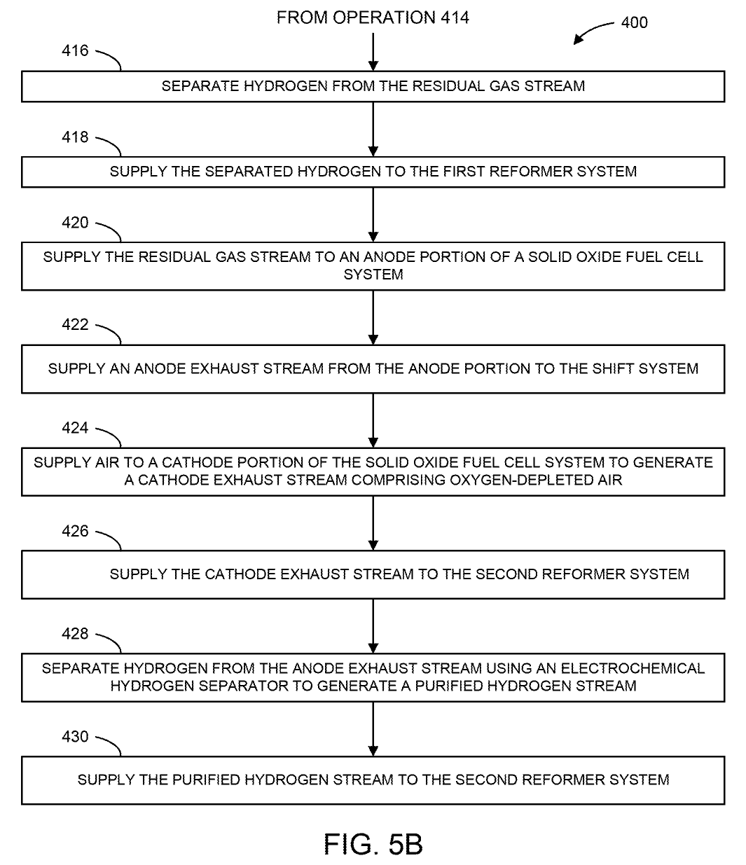

Referring now to FIGS. 5A and 5B, a method 400 of generating ammonia is shown according to an exemplary embodiment. The method 400 may be performed, for example, using the ammonia synthesis systems 100, 200, 300. At operation 402 of the method 400, a natural gas stream is reformed in a first reformer system (e.g., the first reformer system 102) to generate a first reformer system output stream. The natural gas stream may include methane, which may be reformed in a steam-methane reforming reaction (with steam) to form the first reformer system output stream containing hydrogen, carbon dioxide, carbon monoxide, residual methane, and residual steam. At operation 404 of the method 400, the first reformer system output stream is further reformed in a second reformer system (e.g., the second reformer system 110) to generate a second reformer system output stream. The second reformer system may reform the residual methane with oxygen (e.g., from an air stream) and in some cases, residual steam, to form additional carbon monoxide and hydrogen. The second reformer system output stream may include hydrogen, carbon dioxide, carbon monoxide, nitrogen (from the air stream), and residual steam.

At operation 406 of the method 400, the second reformer system output stream is subjected to a water-gas shift reaction in a shift system to generate a shift system output stream. Carbon monoxide and steam undergo a shift reaction to generate carbon dioxide and hydrogen. The shift system output stream may include hydrogen, nitrogen, carbon dioxide, residual carbon monoxide, and residual steam. At operation 408 of the method 400, carbon dioxide in the shift system output stream is removed in an absorber system (e.g., the carbon dioxide absorber system 120) to generate an absorber output stream with relatively little carbon dioxide. The absorber output stream may include primarily hydrogen and nitrogen in addition to small amounts of carbon dioxide, carbon monoxide, and other gases. At operation 410 of the method 400, the absorber output stream 124 is methanated in a methanation system (e.g., the methanation system 126) to form a methanation system output stream. Carbon dioxide and carbon monoxide in the absorber output stream react with hydrogen to form methane. The methanation system output stream may include primarily hydrogen and nitrogen, along with small amounts of methane and other gases. At operation 412 of the method 400, nitrogen and hydrogen in the methanation system output stream are converted to ammonia in an ammonia reactor (e.g., the ammonia reactor 130) to form an ammonia reactor output stream. For example, the hydrogen and nitrogen may react in the presence of a catalyst to form ammonia. The ammonia reactor output stream may include primarily ammonia, in addition to unreacted hydrogen and nitrogen, methane, argon, and other trace gases. At operation 414 of the method 400, the ammonia reactor output stream is separated into a liquid ammonia stream and a residual gas stream (e.g., using a cooling system to cool the ammonia reactor output stream to condense the ammonia to a liquid). The residual gas stream may include hydrogen, nitrogen, methane, argon, and uncondensed ammonia.

At operation 416 of the method 400, hydrogen is separated from the residual gas stream, for example, using a hydrogen separation membrane (e.g., in the hydrogen recovery unit 138). At operation 418 of the method 400, the separated hydrogen is supplied to the first reformer system. The separated hydrogen may be mixed with the natural gas stream supplied to the first reformer system. At operation 420 of the method 400, the residual gas stream is supplied to the anode portion of a solid oxide fuel cell system (e.g., the anode portion 152). After the hydrogen is removed from the residual gas stream in operation 416, the residual gas stream may include nitrogen, methane, argon, ammonia, and residual hydrogen. The ammonia may decompose to form hydrogen and nitrogen, and the methane may be reformed in the anode portion to form additional hydrogen. The anode may output an anode exhaust stream containing hydrogen, nitrogen, argon, and carbon oxides. A portion of the anode exhaust may be purged from the system, for example, to avoid a buildup of argon. At operation 422 of the method 400, the anode exhaust stream is supplied from the anode portion to the shift system. For example, the anode exhaust stream may be mixed with the second reformer system output stream to be recycled to the ammonia reactor downstream. Recycling the anode exhaust stream to the shift system allows for carbon monoxide in the anode exhaust stream to be shifted to carbon dioxide (e.g., in operation 406), for carbon dioxide to be removed from the anode exhaust stream (e.g., in operation 408), and for residual carbon oxides to be methanated (e.g., in operation 410).

At operation 424 of the method 400, air is supplied to the cathode portion of the solid oxide fuel cell system (e.g., the cathode portion 154) to generate a cathode exhaust stream. Oxygen in the cathode may be removed from the air, such that the cathode exhaust stream is or includes oxygen-depleted air. At operation 426 of the method 400, the cathode exhaust stream is supplied to the second reformer system, where oxygen remaining in the cathode exhaust stream may react with methane to form carbon oxides and hydrogen. At operation 428 of the method 400, hydrogen is separated from the anode exhaust stream in an electrochemical hydrogen separator (e.g., EHS 302) to form a purified hydrogen stream. At operation 430 of the method 400, the purified hydrogen stream is supplied to the second reformer system.

It should be understood that in each of operations 402-430 of the method 400, not all of the components of the respective gas streams may react or otherwise be treated as described. For example, in operation 402 reforming the natural gas stream may refer to only a portion of the methane in the natural gas stream being reformed, as some of the methane may pass through the first reformer system without reacting. As another example, not all of the nitrogen and hydrogen in the methanation system output stream may react to form ammonia in operation 412. Some of the hydrogen and nitrogen may pass through the ammonia reactor without reacting. Similarly, not all of a particular gas stream may be supplied to a specific component. For example, a first portion of the anode exhaust stream may be supplied from the anode portion to the shift system, while a second portion of the anode exhaust stream is purged from the system or used for other purposes. It should further be understood that the method 400 may include fewer than all of the operations 402-430. For example, the method may not include operations 416 and 418, and the residual gas stream may be supplied to the anode portion without first separating hydrogen. As another example, if the method 400 includes operations 428 and 430, the method may not include operation 422, as the anode exhaust stream would be supplied to the electrochemical hydrogen separator rather than to the shift system. The method 400 may also include additional operations not listed. For example, the method may include various compression, cooling, and heating operations.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

More particularly, various numerical values herein are provided for reference purposes only. Unless otherwise indicated, all numbers expressing quantities of properties, parameters, conditions, and so forth, used in the specification and claims are to be understood as being modified in all instances by the term “approximately” or “about.” Accordingly, unless indicated to the contrary, the numerical parameters set forth in the following specification and attached claims are approximations. Any numerical parameter should at least be construed in light of the number of significant digits and by applying ordinary rounding techniques. The term “approximately” or “about” when used before a numerical designation, e.g., a quantity and/or an amount including range, indicates approximations which may vary by ( + ) or ( - ) 10 percent.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations are illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. An ammonia synthesis system comprising:
an ammonia reactor configured to convert nitrogen and hydrogen in a first gas stream to ammonia and to output an ammonia reactor output stream; and
a solid oxide fuel cell system comprising an anode portion configured to receive a residual gas stream separated from ammonia in the ammonia reactor output stream.

2. The ammonia synthesis system of claim 1, further comprising an electrochemical hydrogen separator (EHS) configured to receive an anode exhaust stream from the anode portion, and to output a purified hydrogen stream and an EHS purge gas stream comprising residual gas from the anode exhaust stream.

3. The ammonia synthesis system of claim 2, wherein the residual gas stream comprises hydrogen, nitrogen, methane, and ammonia, wherein the solid oxide fuel cell system is configured to reform methane and decompose ammonia.

4. The ammonia synthesis system of claim 2, further comprising:
a first reformer system configured to reform a natural gas stream and output a first reformer system output stream;
a second reformer system configured to reform the first reformer system output stream and output a second reformer system output stream;
a shift system configured to subject the second reformer system output stream to a water-gas shift reaction and to output a shift system output stream;
an absorber system configured to remove carbon dioxide from the shift system output stream and to output an absorber output stream; and
a methanation system configured to methanate the absorber output stream and to output the first gas stream.

5. The ammonia synthesis system of claim 4, wherein the second reformer system is configured to receive the purified hydrogen stream.

6. The ammonia synthesis system of claim 4, wherein the solid oxide fuel cell system comprises a cathode portion configured to receive a cathode input stream comprising air and to output a cathode exhaust stream comprising oxygen-depleted air, wherein the second reformer system is configured to receive at least a portion of the cathode exhaust stream.

7. The ammonia synthesis system of claim 1, further comprising a hydrogen recovery unit configured to remove hydrogen from the residual gas stream before the residual gas stream is received by the anode portion.

8. The ammonia synthesis system of claim 7, further comprising:
a first reformer system configured to reform a natural gas stream and output a first reformer system output stream;
a second reformer system configured to reform the first reformer system output stream and output a second reformer system output stream;
a shift system configured to subject the second reformer system output stream to a water-gas shift reaction and to output a shift system output stream;
an absorber system configured to remove carbon dioxide from the shift system output stream and to output an absorber output stream; and
a methanation system configured to methanate the absorber output stream and to output the first gas stream.

9. The ammonia synthesis system of claim 8, wherein the first reformer system is configured to receive at least a portion of the removed hydrogen from the hydrogen recovery unit.

10. The ammonia synthesis system of claim 8, wherein the anode portion is configured to output an anode exhaust stream, wherein the shift system is configured to receive at least a portion of the anode exhaust stream.

11. The ammonia synthesis system of claim 10, wherein the residual gas stream comprises hydrogen, nitrogen, methane, and ammonia, wherein the solid oxide fuel cell system is configured to reform methane and decompose ammonia.

12. A method of generating ammonia, the method comprising:
converting nitrogen and hydrogen in a first gas stream to ammonia in an ammonia reactor to generate an ammonia reactor output stream;
separating the ammonia reactor output stream into a liquid ammonia stream and a residual gas stream; and
supplying at least a portion of the residual gas stream to an anode portion of a solid oxide fuel cell system.

13. The method of claim 12, wherein the residual gas stream comprises hydrogen, nitrogen, methane, and ammonia, and the solid oxide fuel cell system is configured to cause components of the at least the portion of the residual gas stream in the solid oxide fuel cell system to react to generate an anode exhaust stream, the method further comprising separating hydrogen from the anode exhaust stream using an electrochemical hydrogen separator to generate a purified hydrogen stream.

14. The method of claim 13, wherein causing the components of the at least the portion of the residual gas stream in the solid oxide fuel cell system to react comprises reforming methane and decomposing ammonia.

15. The method of claim 12, further comprising:
reforming a natural gas stream in a first reformer system to generate a first reformer system output stream;
reforming the first reformer system output stream in a second reformer system to generate a second reformer system output stream;
subjecting the second reformer system output stream to a water-gas shift reaction in a shift system to generate a shift system output stream;
removing carbon dioxide from the shift system output stream in an absorber system to generate an absorber output stream; and
methanating the absorber output stream in a methanation system to generate the first gas stream.

16. The method of claim 15, wherein the solid oxide fuel cell system is configured to cause components of the at least the portion of the residual gas stream in the solid oxide fuel cell system to react to generate an anode exhaust stream, the method further comprising separating hydrogen from the anode exhaust stream using an electrochemical hydrogen separator to generate a purified hydrogen stream, the method further comprising supplying at least a portion of the purified hydrogen stream to the second reformer system.

17. The method of claim 16, further comprising:
supplying air to a cathode portion of the solid oxide fuel cell system to generate a cathode exhaust stream comprising oxygen-depleted air; and
supplying at least a portion of the cathode exhaust stream to the second reformer system.

18. The method of claim 15, further comprising removing hydrogen from the at least the portion of the residual gas stream before supplying the at least the portion of the residual gas stream to the anode portion and supplying the removed hydrogen to the first reformer system.

19. The method of claim 18, wherein the solid oxide fuel cell system is configured to cause components of the at least the portion of the residual gas stream in the solid oxide fuel cell system to react to generate an anode exhaust stream, the method further comprising supplying at least a portion of the anode exhaust stream from the anode portion to the shift system.

20. The method of claim 19, wherein the at least the portion of the residual gas stream comprises hydrogen, nitrogen, methane, and ammonia, wherein causing the components of the at least the portion of the residual gas stream in the solid oxide fuel cell system comprises reforming methane and decomposing ammonia.
